(19) United States
(12) Patent Application Publication
(10) Pub. No.: US 2001/0050536 A1
(43) Pub. Date: Dec. 13, 2001

(54) Electrode for discharge tube, and discharge tube using it

(75) Inventors: Nobuharu Harada, Hamamatsu-shi (JP); Syoji Ishihara, Hamamatsu-shi (JP)

Correspondence Address: MORGAN, LEWIS & BOCKIUS, 1800 M STREET NW, WASHINGTON, DC, 20036-5869, US

(73) Assignee: HAMAMATSU PHOTONICS K.K.

(21) Appl. No.: 09/910,719

(22) Filed: Jul. 24, 2001

Related U.S. Application Data
(63) Continuation-in-part of application No. PCT/JP00/00382, filed on Jan. 26, 2000.

(30) Foreign Application Priority Data
Jan. 26, 1999 (JP) P1999-017296

(51) Int. Cl. H01J 17/18

(52) U.S. Cl. 313/623

(57) ABSTRACT

A discharge tube is comprised of a glass bulb, a cathode, and an anode. The cathode consists of a cathode tip portion of a bullet shape made by impregnating porous tungsten with barium, and a cylindrical lead rod of molybdenum having a recess. Apart of a base of the cathode tip portion is placed in the recess of the lead rod and a clearance between the internal surface of the recess of the lead rod and the side face of the insert part of the cathode tip portion is sealed with a molybdenum-ruthenium brazing filler metal.

### RELATED APPLICATION

This is a continuation-in-part application of application Ser. No. PCT/JP00/00382 filed on Jan. 26, 2000, now pending.

### BACKGROUND OF THE INVENTION

1. Field of the Invention

The present invention relates to an electrode for discharge tube, and a discharge tube using it.

2. Related Background Art

Discharge tubes are commonly used as light sources for illumination and instrumentation. The discharge tubes are light sources in which a cathode and an anode are included opposite to each other in a discharge gas atmosphere and in which arc discharge is induced between the cathode and the anode to emit light. Such discharge tubes are provided, for example, with the electrode as disclosed in Japanese Patent Application Laid-Open NO. S62-241254. This electrode is one in which a main body is made by sintering a mixture of a refractory metal, e.g. tungsten, and an electron-emissible substance, e.g. an oxide of an alkaline earth metal, the main body is put in a tubular part (recess) of a base section made of a refractory metal, e.g. molybdenum, and the bottom face of the main body is fixed to the bottom face of the tubular part of the base section by brazing or the like. When the main body contains the electron-emissible substance as in the case of the above electrode, it becomes easier for the electrode to emit electrons and the electrode suffers less damage at the tip.

There are also discharge tubes having similar structure and using the electrode with the main body made by impregnating the refractory metal with the electron-emissible substance, for example, as disclosed in Japanese Utility Model No. H04-3388.

### SUMMARY OF THE INVENTION

However, the above discharge tubes, particularly, the above electrodes used in such discharge tubes, had the problem described below. The problem was that in the electrodes of the discharge tubes according to the above prior arts, there was a large clearance between the internal surface of the tubular part (recess) of the base section and the side face of the main body placed in the tubular part (Japanese Patent Application Laid-Open No. S62-241254), or no consideration was given to such a clearance at all (Japanese Utility Model No. H04-3388). With existence of this clearance, however, the electron-emissible substance remaining in the clearance will evaporate with a rise in temperature during operation of the discharge tube to be deposited on the wall surface of the discharge tube. As a consequence, the discharge tube will decrease its quantity of output light, and the life of the discharge tube will be shortened.

It is, therefore, an object of the present invention to solve the above problem and provide a discharge tube with a long life and a discharge tube electrode used therein.

In order to accomplish the above object, an electrode for discharge tube according to the present invention is a discharge tube electrode used in a discharge tube in which a cathode and an anode are included opposite to each other in a discharge gas atmosphere and in which arc discharge is induced between the cathode and the anode, the electrode comprising a main body made of a refractory metal containing an electron-emitting (or -emissible) substance and having a cusp at one end thereof, and a base section made of a refractory metal and having a recess to accommodate another end of the main body, wherein a clearance between an internal surface of the recess of the base section and a side face of the main body placed in the recess is sealed with a brazing filler metal.

Since the clearance between the internal surface of the recess of the base section and the side face of the main body placed in the recess is sealed with the brazing filler metal, the electron-emissible substance is prevented from entering the clearance from the outside, and even if the electron-emissible substance bleeds out of the side face of the main body into the clearance the electron-emissible substance will be prevented from being emitted from the clearance to the outside.

In the discharge tube electrode of the present invention, the brazing filler metal may be filled in the clearance.

When the brazing filler metal is filled in the clearance, heat transfer efficiency is increased between the main body and the base section through the brazing filler metal.

In the discharge tube electrode of the present invention, the brazing filler metal may also be provided on an exposed portion of the side face of the main body outside the recess.

Since the brazing filler metal is also provided on the exposed portion of the side face of the main body outside the recess, it can prevent the electron-emissible substance bleeding out of that portion of the main body from being emitted to the outside.

In the discharge tube electrode of the present invention, the main body may be comprised of an impregnated metal made by impregnating a porous refractory metal with an electron-emissible substance.

Since the main body is comprised of the impregnated metal made by impregnating the porous refractory metal with the electron-emissible substance, the electron-emissible substance becomes uniformly included in the main body, thereby enhancing uniformity of output light. When the main body is made to include the electron-emissible substance by impregnation, the main body of the refractory metal is normally impregnated with the electron-emissible substance after the main body is placed in the recess of the base section. Since the clearance between the internal surface of the recess of the base section and the side face of the main body placed in the recess is sealed with the brazing filler metal, the electron-emissible substance is also prevented from entering the clearance during the impregnation with the electron-emissible substance.

In the discharge tube electrode of the present invention, the brazing filler metal may be a material having a melting point lower than those of the main body and the base section and higher than an impregnation temperature for the impregnation of the main body with the electron-emissible substance.

When the brazing filler metal is the material having the melting point lower than those of the main body and the base section, the shapes of the main body and the base section are maintained even during the sealing operation of the clearance by heating to melt the brazing filler metal. Since the brazing filler metal has the melting point higher than the impregnation temperature, the brazing filler metal is prevented from evaporating or deforming during the impregnation.

In the discharge tube electrode of the present invention, the brazing filler metal may be a molybdenum (Mo)-ruthenium (Ru) brazing filler metal.

In the discharge tube electrode of the present invention, the electron-emissible substance may comprise a simple substance or an oxide of an alkaline earth metal.

Since the electron-emissible substance is a simple substance or an oxide of an alkaline earth metal, it becomes feasible to effectively decrease the work function of the main body.

The discharge tube electrode of the present invention may further comprise a coating of a refractory metal for covering the surface of the main body while exposing the tip of the cusp of the main body.

When the electrode is provided with such a coating, it becomes feasible to more effectively prevent the electron-emissible substance bleeding out of the side face of the main body from evaporating to the outside.

In order to accomplish the above object, a discharge tube of the present invention is a discharge tube in which a cathode and an anode are included opposite to each other in a discharge gas atmosphere and in which arc discharge is induced between the cathode and the anode, wherein at least one of the cathode and the anode is either one of the discharge tube electrodes described above.

By use of either of the above electrodes, the electron-emissible substance is prevented from going from the outside into the clearance between the internal surface of the recess of the base section of the electrode and the side face of the main body placed in the recess, and even if the electron-emissible substance bleeds out of the side face of the main body into the clearance the electron-emissible substance will be prevented from being emitted from the clearance to the outside.

### BRIEF DESCRIPTION OF THE DRAWING

FIG. 1 is a cross-sectional view of a discharge tube.

FIG. 2 is a cross-sectional view of an electrode.

FIG. 3A, FIG. 3B, FIG. 3C, and FIG. 3D are fabrication step diagrams of the electrode.

FIG. 4 is a graph to show temporal changes in output of discharge tubes.

FIG. 5 is a cross-sectional view of another electrode.

### DESCRIPTION OF THE PREFFERED EMBODIMENT

A discharge tube according to an embodiment of the present invention will be described with reference to the drawings. A discharge tube electrode according to an embodiment of the present invention is included in the discharge tube of the present embodiment.

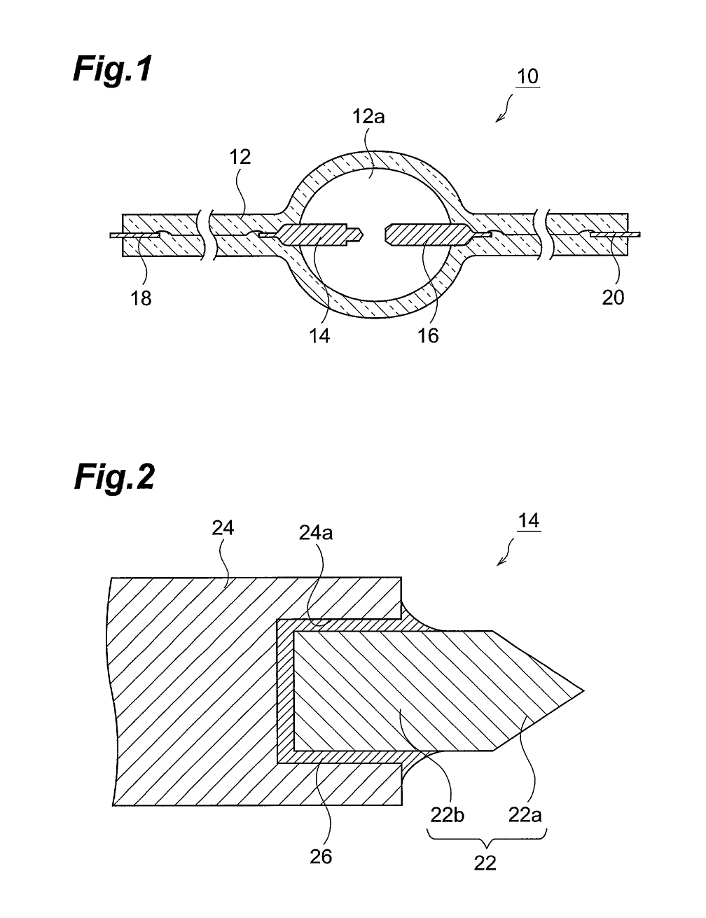

First, the structure of the discharge tube according to the present embodiment will be described. FIG. 1 is a cross-sectional view of the discharge tube according to the present embodiment. The discharge tube 10 of the present embodiment is provided with a glass bulb 12, a cathode 14, and an anode 16.

The glass bulb 12 is made of quartz and has a substantially rodlike shape. A hollow gas enclosure 12a is formed in an intermediate portion of the glass bulb 12 and a discharge gas, e.g. xenon, is confined inside this enclosure. Inside the gas enclosure 12a, there are the cathode 14 and the anode 16 placed opposite to each other. The cathode 14 and the anode 16 are electrically connected to external terminals 18, 20, respectively, disposed at the two ends of the glass bulb 12. When a voltage is placed between the cathode 14 and the anode 16 through the external terminals 18, 20, arc discharge is generated between the cathode 14 and the anode 16, so as to emit light.

FIG. 2 is a cross-sectional view of the cathode 14, which is one of the electrodes. The cathode 14 is comprised of a cathode tip portion 22 (main body) and a lead rod 24 (base section). The cathode tip portion 22 is made by impregnating porous tungsten (refractory metal) with barium (electron-emitting (or -emissible) substance). The impregnation with barium being an alkaline earth metal can decrease the work function of the cathode tip portion 22 to facilitate emission of electrons. The cathode tip portion 22 has a bullet shape consisting of a conical cusp 22a provided on one end side to face the anode 16 and a cylindrical base 22b provided on the other end side.

The lead rod 24 is made of molybdenum (refractorymetal) and has a cylindrically extending shape. A recess 24a for accommodating (a part of) the base 22b of the cathode tip potion 22 is formed on one end side of the lead rod 24 and the other end side of the lead rod 24 is fixed to the glass bulb 12. Describing in more detail, the recess 24a is a cylindrical recess having the inside diameter approximately several μm to several hundred μm larger than the diameter of the base 22b of the cathode tip portion 22 and having the depth enough to accommodate at least a part of the base 22b of the cathode tip portion 22.

The part of the base 22b of the cathode tip portion 22 (which will be referred to hereinafter as an insert part) is placed in the recess 24a of the lead rod 24 and the bottom face of the base 22b of the cathode tip portion 22 is bonded and fixed to the bottom face of the recess 24a of the lead rod 24 with molybdenum (Mo)-ruthenium (Ru) brazing filler metal 26. The clearance between the internal surface of the recess 24a of the lead rod 24 and the side face of the insert part of the cathode tip portion 22 is sealed with the Mo-Ru brazing filler metal 26 so as to isolate the clearance from the outside. More specifically, the Mo-Ru brazing filler metal 26 is filled in the clearance and the Mo-Ru brazing filler metal 26 is further provided continuously up to over a part except for the recess 24a in the end face of the lead rod 24 and up to over the side face except for the insert part in the base 24b of the cathode tip portion 22, i.e., up to over the exposed portion outside the recess 24a. Here, particularly, the melting point of the Mo-Ru brazing filler metal 26 is 1950° and is thus lower than the melting point of tungsten (3410° C.) as the material of the cathode tip portion 22 and the melting point of molybdenum (2620° C.) as the material of the lead rod 24 and higher than the impregnation temperature (about 1500° C.) for the impregnation of barium into the cathode tip portion 22.

The anode 16 is made of tungsten and has a shape in which a tip portion of a frustum of circular cone provided on one end side to face the cathode 14 is connected to a cylindrical base, as illustrated in FIG. 1.

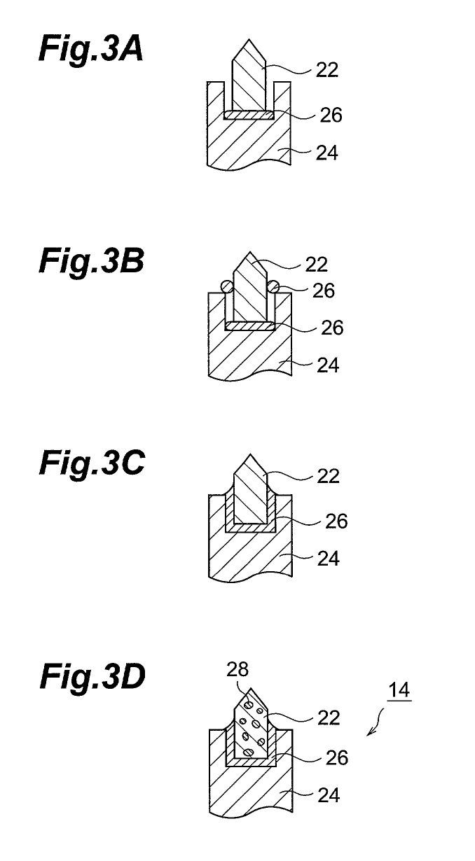

In the next place, a method of fabricating the cathode 14, which is one characteristic portion of the discharge tube according to the present embodiment, will be described. FIGS. 3A to FIG. 3D are step diagrams to show fabrication steps of the cathode 14. For fabricating the cathode 14, as illustrated in FIG. 3A, the insert part of the cathode tip portion 22 is first inserted into the recess 24a of the lead rod 24 and then the bottom face of the base 22a of the cathode tip portion 22 is bonded and fixed to the bottom face of the recess 24a of the lead rod 24 with the Mo-Ru brazing filler metal 26. Such bonding and fixing is implemented by preliminarily charging the Mo-Ru brazing filler metal 26 onto the bottom face of the recess 24a of the lead rod 24, then placing the insert part of the cathode tip portion 22 thereon, and thereafter heating the Mo-Ru brazing filler metal 26.

After that, as illustrated in FIG. 3B, the Mo-Ru brazing filler metal 26 formed in a ring shape is placed so as to contact both the periphery of the base 22b of the cathode tip portion 22 and the edge of the recess 24a of the lead rod 24.

After the above step, the Mo-Ru brazing filler metal 26 is heated whereby the Mo-Ru brazing filler metal 26 is filled in the clearance between the internal surface of the recess 24a of the lead rode 24 and the side face of the insert part of the cathode tip portion 22, as illustrated in FIG. 3C. By appropriately controlling the amount of the Mo-Ru brazing filler metal 26 herein, the Mo-Ru brazing filler metal 26 can also be continuously formed up to over a part except for the recess 24a in the end face of the lead rod 24 and up to over the side face except for the insert part in the base 22b of the cathode tip portion 22. Since the melting points of the materials making the cathode tip portion 22 and the lead rod 24 are higher than the melting point of the Mo-Ru brazing filler metal 26, the cathode tip portion 22 and the lead rod 24 are prevented from undergoing thermal deformation during the heating process to melt the Mo-Ru brazing filler metal 26.

After that, as illustrated in FIG. 3D, the cathode tip portion 22 is impregnated with barium 28 under an atmosphere of about 1500° C. Since the melting point of the Mo-Ru brazing filler metal 26 is higher than the impregnation temperature, the Mo-Ru brazing filler metal 26 is prevented from evaporating or deforming during the impregnation of barium 28. Since the cathode tip portion 22 is made to include barium 28 of an electron-emissible substance by the impregnation, barium 28 becomes uniformly included in the cathode tip portion 22, so as to enhance uniformity of output light.

Next, the action and effect of the discharge tube according to the present embodiment will be described. In the discharge tube 10 of the present embodiment, the cathode 14 is constructed by sealing the clearance between the internal surface of the recess 24a of the lead rod 24 and the side face of the insert part of the cathode tip portion 22 with the Mo-Ru brazing filler metal 26 and, particularly, by sealing the clearance so as to fill the clearance with the Mo-Ru brazing filler metal 26. Accordingly, the electron-emissible substance of barium or the like is prevented from entering the clearance from the outside, and even if the electron-emissible substance bleeds out of the side face of the cathode tip portion 22 into the clearance the electron-emissible substance will be prevented from being emitted from the clearance to the outside. Even if there is a rise in the ambient temperature during operation of the discharge tube 10, the electron-emissible substance will be prevented from evaporating and attaching to the wall surface of the discharge tube 10. As a result, it becomes feasible to maintain the quantity of output light of the discharge tube 10 well over a long period and thus extend the life of the discharge tube 10.

In the discharge tube 10 of the present embodiment, the Mo-Ru brazing filler metal 26 is further provided continuously up to over the part except for the recess 24a in the end face of the lead rod 24 and up to over the side face except for the insert part in the base 22b of the cathode tip portion 22, i.e., up to over the exposed portion outside the recess 24a. Accordingly, even if the electron-emissible substance bleeds out of the side face except for the insert part in the base 22b of the cathode tip portion 22, the electron-emissible substance will be prevented from being emitted to the outside. As a result, it becomes feasible to further extend the life of the discharge tube.

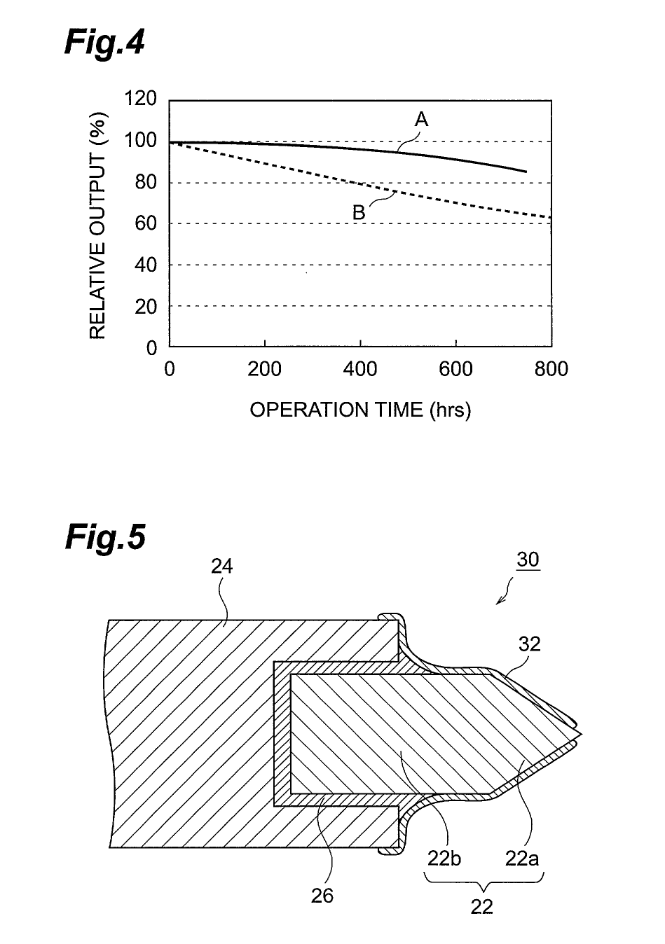

FIG. 4 is a graph to show temporal changes in output of the discharge tube 10 of the present embodiment (indicated by A in FIG. 4) and a discharge tube of prior art (indicated by B in FIG. 4). Here the discharge tube of prior art is one provided with the cathode in which only the bottom face of the base of the cathode tip portion is bonded and fixed to the bottom face of the recess of the lead rod with the Mo-Ru brazing filler metal and in which the Mo-Ru brazing filler metal is not filled in the clearance between the internal surface of the recess of the lead rod and the side face of the insert part of the cathode tip portion. As apparent from FIG. 4, the discharge tube of prior art decreases its light output to about 60% of the initial output after 800-hour operation, whereas the discharge tube 10 of the present embodiment is able to maintain its light output over 80% of the initial output even after operation for near 800 hours.

Further, since the discharge tube 10 of the present embodiment is constructed by filling the clearance between the internal surface of the recess 24a of the lead rod 24 and the side face of the insert part of the cathode tip portion 22 with the Mo-Ru brazing filler metal 26, heat transfer efficiency is increased between the cathode tip portion 22 and the lead rod 24 through the Mo-Ru brazing filler metal 26. As a result, it becomes feasible to effectively radiate heat generated in the cathode tip portion 22 into the lead rod 24 and effectively prevent a rise in temperature of the discharge tube 10.

In the case of the structure in which only the bottom face of the base 22b of the cathode tip portion 22 was bonded and fixed to the bottom face of the recess 24a of the lead rod 24 with the Mo-Ru brazing filler metal 26, there occurred dispersion in heat transfer efficiency from the cathode tip portion to the lead rode 24, depending upon the thickness, deposition position, etc. of the Mo-Ru brazing filler metal 26, and there also occurred dispersion in performance of discharge tubes. In contrast with it, the discharge tube 10 of the present embodiment is able to prevent occurrence of such dispersion by filling the Mo-Ru brazing filler metal 26 in the clearance between the internal surface of the recess 24a of the lead rod 24 and the side face of the insert part of the cathode tip portion 22, and discharge tubes can be fabricated without dispersion of performance.

The cathode of the discharge tube 10 of the above embodiment can also be a cathode 30 as illustrated in FIG. 5. Namely, the cathode 30 is further provided with a metal coating 32 of iridium (refractory metal) for covering the surface of the cathode tip portion 22 while exposing the tip of the cusp 22a of the cathode tip portion 22, when compared with the cathode 14. The metal coating 32 is readily made by depositing iridium in the thickness of about 2000 Å on the surface of the cathode tip portion 22 by a CVD method, a sputtering method, or the like and thereafter removing the metal coating 32 located at the tip of the cusp 22a of the cathode tip portion 22 by a polishing treatment with sand paper, an ablation process with laser, or the like. The provision of the metal coating 32 makes it feasible to more effectively prevent the evaporation of the electron-emissible substance bleeding out of the side face of the cathode tip portion 22. When the metal coating 32 is provided so as to cover a wide range enough to contact the lead rod 24, the heat transfer efficiency is increased from the cathode tip portion 22 to the lead rod 24 whereby temperature increase of the discharge tube 10 can be prevented effectively.

In the discharge tube 10 of the above embodiment the cathode tip portion 22 was made of tungsten and the lead rod 24 of molybdenum, but they may also be made of other materials such as rhenium, tantalum, and soon. The material of the cathode tip portion 22 can be the same as or different from the material of the lead rod 24.

In the discharge tube 10 of the above embodiment, the electron-emissible substance was barium, but it can also be another material, e.g., a simple substance or an oxide of an alkaline earth metal such as calcium, strontium, or the like. The electron-emissible substance may be a mixture of two or more above simple substances or oxides.

The discharge tube 10 of the above embodiment was provided with the impregnated type cathode tip portion 22 made by the impregnation of the electron-emissible substance, but it may also be replaced by a sintered type cathode tip portion obtained by simultaneously sintering powder of a refractory metal, e.g. tungsten, and powder of an electron-emissible substance, e.g. barium.

In the discharge tube 10 of the above embodiment the Mo-Ru brazing filler metal 26 was filled in the clearance between the internal surface of the recess 24a of the lead rod 24 and the side face of the insert part of the cathode tip portion 22, but the necessary condition is that the clearance is isolated from the outside by sealing the clearance between the internal surface of the recess 24a of the lead rod 24 and the side face of the insert part of the cathode tip portion 22; therefore, the brazing filler metal does not have to be filled everywhere without any space.

Since in the discharge tube electrode of the present invention the clearance between the internal surface of the recess of the base section and the side face of the main body placed in the recess is sealed with the brazing filler metal, the electron-emissible substance is prevented from entering the clearance from the outside, and even if the electron-emissible substance bleeds out of the side face of the main body into the clearance the electron-emissible substance will be prevented from being emitted from the clearance to the outside. Therefore, even if there is a rise in the ambient temperature during the operation of the discharge tube, the electron-emissible substance will be prevented from evaporating and attaching to the wall surface of the discharge tube. As a result, it becomes feasible to maintain the quantity of output light of the discharge tube well over a long period and thus extend the life of the discharge tube.

In the discharge tube electrode of the present invention, the heat transfer efficiency is increased between the main body and the base section through the brazing filler metal, because the brazing filler metal is filled in the clearance. As a result, it becomes feasible to radiate the heat generated in the main body effectively into the base section and effectively prevent the temperature increase of the discharge tube.

Further, in the discharge tube electrode of the present invention, the brazing filler metal is also provided on the exposed portion of the side face of the main body outside the recess whereby the electron-emissible substance bleeding out of the exposed portion of the main body is prevented from being emitted to the outside. As a result, it becomes feasible to further extend the life of the discharge tube.

Since the discharge tube of the present invention uses the discharge tube electrode described above, the electron-emissible substance is prevented from going from the outside into the clearance between the internal surface of the recess of the base section of the electrode and the side face of the main body placed in the recess, and even if the electron-emissible substance bleeds out of the side face of the main body into the clearance the electron-emissible substance will be prevented from being emitted from the clearance to the outside. Even if there is a rise in the ambient temperature during the operation of the discharge tube, the electron-emissible substance will be prevented from evaporating and attaching to the wall surface of the discharge tube accordingly. As a result, it becomes feasible to maintain the quantity of output light of the discharge tube well over a long period and thus extend the life of the discharge tube.

What is claimed is:

1. A discharge tube electrode used in a discharge tube in which a cathode and an anode are included opposite to each other in a discharge gas atmosphere and in which arc discharge is induced between the cathode and the anode, said electrode comprising:
a main body made of a refractory metal containing an electron-emitting substance and having a cusp at one end thereof; and
a base section made of a refractory metal and having a recess to accommodate another end of said main body,
wherein a clearance between an internal surface of said recess of the base section and a side face of said main body placed in the recess is sealed with a brazing filler metal.

2. The discharge tube electrode according to claim 1, wherein said brazing filler metal is filled in said clearance.

3. The discharge tube electrode according to claim 1, wherein said brazing filler metal is also provided on an exposed portion of the side face of the main body outside said recess.

4. The discharge tube electrode according to claim 1, wherein said main body is comprised of an impregnated metal made by impregnating a porous refractory metal with an electron-emitting substance.

5. The discharge tube electrode according to claim 4, wherein said brazing filler metal is comprised of a material having a melting point lower than those of said main body and said base section and higher than an impregnation temperature for the impregnation of said main body with said electron-emitting substance.

6. The discharge tube electrode according to claim 5, wherein said brazing filler metal is a molybdenum-ruthenium brazing filler metal.

7. The discharge tube electrode according to claim 1, wherein said electron-emitting substance comprises a simple substance or an oxide of an alkaline earth metal.

8. The discharge tube electrode according to claim 1, further comprising a coating of a refractory metal for covering the surface of said main body while exposing the tip of said cusp of said main body.

9. A discharge tube in which a cathode and an anode are included opposite to each other in a discharge gas atmosphere and in which arc discharge is induced between said cathode and said anode,
wherein at least one of said cathode and said anode is the discharge tube electrode as set forth in claim 1.
